(19) United States
(12) Patent Application Publication
(10) Pub. No.: US 2017/0339769 A1
(43) Pub. Date: Nov. 23, 2017

(54) ADAPTER EXTENDING CAPABILITIES OF REMOTE CONTROL AND LiFi TO INSTALLATIONS OF DEVICES INCLUDING LIGHT-EMITTING DIODE-BASED LUMINAIRES

(71) Applicant: BASIC6, INC., Westport, CT (US)

(72) Inventors: Magnus WENNEMYR, Amherst, MA (US); John ASH, Trumbull, CT (US); Victor ANSART, Greenwich, CT (US)

(21) Appl. No.: 15/398,464

(22) Filed: Jan. 4, 2017

Related U.S. Application Data
(60) Provisional application No. 62/274,619, filed on Jan. 4, 2016.

(51) Int. Cl. H05B 37/02; H04L 29/12; H04L 29/08; H05B 33/08

(52) U.S. Cl. CPC H05B 37/0272; H05B 33/0845; H05B 33/0812; H04L 61/20; H04L 67/12; H04L 61/6022

(57) ABSTRACT

An adapter for connection between a luminaire and a power input for powering the luminaire comprises circuitry for modulating light output of the luminaire to contain information, or circuitry for connection to a network so that signals associated with the luminaire are communicated on the network. The adapter is placed between the luminaire and a power input for the luminaire. Methods are provided for registering and establishing communication between a gateway device and a management platform, and for registering a luminaire device with the gateway so that it can be managed by the management platform. Portions of the larger system that constitutes the remote controlled lighting system are also described, including connected wall switches, sensors, and the gateways themselves.

This application claims priority from and the benefit of U.S. provisional application Ser. No. 62/274,619 filed on Jan. 4, 2016.

### CROSS REFERENCE TO RELATED APPLICATIONS

This application is related to patent application Ser. No. 14/671,694 filed on Mar. 27, 2015, published as United States Patent Publication No. 2015/0281337, which claims priority from and the benefit of provisional patent application Ser. No. 61/972,754, filed on Mar. 31, 2014. These applications are incorporated herein by reference, in their entirety, for all purposes.

### BACKGROUND OF THE DISCLOSURE

### 1. Field of the Disclosure

The present disclosure relates to the Internet of Things (IoT). The IoT is essentially the set of connectable and identifiable electronic devices that are increasingly installed in our surroundings. More particularly, this disclosure also relates to the technology of light-emitting diodes (LED), semi-conductor based lighting, that have many advantages over incandescent light sources including lower energy consumption, longer lifetime, improved physical robustness, smaller size, and faster switching.

### 2. Description of the Related Art

With the IoT “smart” devices have proliferated; devices capable of a greater range of functionality and communication. Focus in this burgeoning field is at this time largely on the “Application” side (your door at home opens, you get a text). The way such devices operate is typically with a microcontroller (MCU)-based program that collects data about and controls its environment via sensors and actuators. Smart devices include WiFi or other communication modes, and sometimes even an external microprocessor (MPU) running full-fledged operating systems that greatly extend the device's capabilities. In such cases, the application running on the MCU may call libraries on the MPU to process information to inform device control decisions, and the application may send data back targeting a customer's data store.

It is the capability of LEDs that enables light to be used as a medium over which data can be communicated from an LED to a light-sensitive receiver. In its simplest form, this visible light communications (VLC) works by switching the LEDs off and on at a very high rate in patterns that communicate information. With an additional light sensitive receiver and accompanying circuitry, the LED can become a node capable of bidirectional communication. For this to be meaningful, an appropriate light sensitive receiver and transmitter at a far end would be required. In its simplest form, an LED may be used to emit a repeated uniquely identifying pattern, an “ID”, which can be used by a receiving device to pinpoint its location when it is in the path of the light emitted by the LED (“GeoLiFi”). For convenience, the terms LiFi and VLC will be used to describe communication of data by blinking an LED in any fashion, irrespective of whether there exists a bidirectional capability.

Smarter devices imply a need for efficient, secure, and reliable status monitoring and maintenance as well as control, and in the case of LEDs or other emitters such as Bluetooth-based beacons, sometimes the need to communicate information to consumers emitted by the devices themselves. It is these needs that are addressed by the current disclosure.

With the advent of the LED technology much existing street lighting and lighting in retail stores and other venues have been or will be retrofitted with the newer LED technology to replace older types of lights. This is considered an opportunity by providers of IoT-capable lights—lights outfitted with networking capabilities, and optionally even sensors and actuators in addition to the LEDs themselves—to leverage the process of retrofitting lighting to also add IoT capabilities.

For optimal and secure monitoring, maintenance and employment of controls, it is typically necessary to securely collect significant volumes of data, present the same in meaningful ways to users, and provide the means to effect global changes of installations as determined by higher level intelligent agents, by setting schedules or by directly controlling devices from interfaces that update the states of devices in real time.

### SUMMARY OF THE DISCLOSURE

In general, the disclosure addresses technology that can be encased fully or partly within the luminaire during the manufacturing stages. Furthermore, it also addresses the particular use case where IoT and LiFi-incapable LEDs have already been installed. For that, an adapter and accompanying system has been designed and a fully functioning prototype implemented whereby the capabilities of an existing LED is extended with IoT and LiFi capabilities, without requiring the replacement of the LED. The same adapter may be installed during manufacturing. The term device is here used to describe the entire smart LED luminaire, including the adapter. The device can be placed within and is part of a distributed computational environment that brings data from and control to the device from across the globe.

The disclosure is directed to an adapter for connection between a luminaire and a power input for powering the luminaire, comprising circuitry for modulating light output of the luminaire to contain information, or circuitry for connection to a network so that signals associated with the luminaire are communicated on the network

The disclosure is also directed to a device or apparatus comprising a luminaire; a power input for the luminaire; and an adapter for connection between the luminaire and the power input for controlling the luminaire, by at least one of the adapter modulating light output of the luminaire to contain information, or the adapter having a connection to a network so that the luminaire communicates via signals on the network.

In another aspect, the disclosure is directed to methods for securely registering such devices and gateways for such devices, and for allowing the devices to be securely controlled by a management platform via the gateway. The system comprised of all these parts, from the management platform through to the connected devices is referred to as the Lighting Application.

Included in this disclosure is the description of circuitry that significantly minimizes the noise that LED drivers experience during modulation of the light.

The model by which data collection from multiple sites containing potentially large numbers of devices and by which control is exercised over those devices is accomplished herein by connecting gateways to a complex remote computing system (a Cloud). Each gateway is wirelessly connected to a number of simpler devices such as the luminaires containing the LEDs to be managed. Data and controls are then sent between the devices and Cloud over the gateways, the latter which are more complex, capable of managing and coordinating the activities of the connected devices, and of managing a persistent connection to the Cloud. The gateways are connected to a smaller or larger number of devices depending on factors such as the distance between the devices, the wireless range of the devices, and the spatial geometry of the installation space.

For the purposes of retro-fitting existing luminaires or other containers of sensors, actuators, or emitters, wireless solutions such as Bluetooth need not depend on existing physical networking infrastructure, such as the presence of Ethernet cabling.

The gateway connects to devices using Bluetooth-based networking modules manufactured by a third-party such as, for example, Cambridge Silicon Radio (CSR). In this manner the gateway extends the exchange of data and control from the local Bluetooth range by indirectly connecting the meshed devices to the Cloud. On principle, any local networking technology such as ZigBee or Z-wave could be used between the gateway and the devices.

For the typical use case where devices are deployed indoors and interspersed at typical luminaire distances, low-energy Bluetooth (BLE) based meshes are preferred for reasons that the Bluetooth protocol is considered secure, is actively enhanced with respect to support of IoT use cases, is widely available on mobile phones which can therefore potentially communicate directly with the gateways or devices at the local level without enhancement, and can connect large numbers of devices in practice.

The chosen network topology used by the chosen devices is based on the principle that each meshed communication node, as attached to a device, is capable of mediating communications targeting any other node, without any concept of router, coordinator, or “end” device. This model simplifies communication protocols and extends the range of the most distant device from the gateway by allowing any number of mediated hops along the way, as a higher chance that messages will get through to receiving nodes allows for a lower scan rate, and the resulting mesh can be considered self-healing.

A technology whereby heterogeneity of the gateway and mesh embodiments can be accommodated in greatly simplified fashion through the use of agent-managed plugins is also disclosed.

For street lighting or other deployment types the same general concept may require a mesh or different networked topology that uses different radio signal modes capable of communication over greater distances. That is easily accommodated within the software of the system as a whole by customizing a plugin for that purpose, and by using gateways and devices leveraging a different communication mode.

Primarily for the purposes of flexibility, the JSON protocol can be used to provide functionality along the communication channel between the gateway and the Cloud to which it is connected. A condensed, proprietary format of signals between the gateway and mesh-connected devices can be employed in order to reduce traffic across the bandwidth-limited mesh nodes.

### BRIEF DESCRIPTION OF THE DRAWINGS

FIG. 1 is a block diagram of a system including an embodiment of the adapter disclosed herein.

FIG. 2 is a block diagram of the embodiment of the adapter of FIG. 1.

FIG. 3 is a schematic diagram of an adapter in accordance with FIG. 1.

FIG. 4 is a block diagram of an adapter including a light sensor.

FIG. 5 is a block diagram of an adapter including environmental sensors.

FIG. 6 is a schematic diagram of an adapter used to manage illumination or actuators, remotely.

FIG. 7 is a block diagram of an alternate arrangement for configuring an existing LED to emit a GeoLiFi identification.

FIG. 8 is a system diagram that shows the adapters disclosed herein being managed from a cloud-based management system.

FIG. 9 is a flow chart of the manner in which a gateway is securely registered to a management platform.

FIG. 10 is a flow chart of the manner in which a connection with a server is established.

FIG. 11 is a flowchart depicting an alternate form of secure registration of a gateway and use of a device associated therewith.

FIG. 12 is a flow chart of the manner in which a device establishes communication to the platform via a gateway.

FIG. 13 is a high level block diagram of the plugin-oriented device agent architecture.

FIG. 14 is a block diagram of the flow of control to the plugin device of FIG. 11.

FIG. 15 is a circuit schematic describing a gateway.

FIG. 16A, FIG. 16B and FIG. 16C, when assembled with FIG. 16B to the right of FIG. 16A, and FIG. 16C under FIG. 16A, with broken connection lines properly connected, are a circuit schematic depicting an embodiment of a board that provides control of an LED and modulates a VLC signal.

FIG. 17 is a schematic diagram depicting a board used as a switch on the mesh to provide local control of lights to the system.

FIG. 18 is a schematic diagram depicting a board used to provide occupancy sensor and lumens sensor capabilities to the system, to control the lights locally as well as feed the data to the Cloud.

A component or a feature that is common to more than one drawing is indicated with the same reference number in each of the drawings.

### DESCRIPTION OF THE EMBODIMENTS

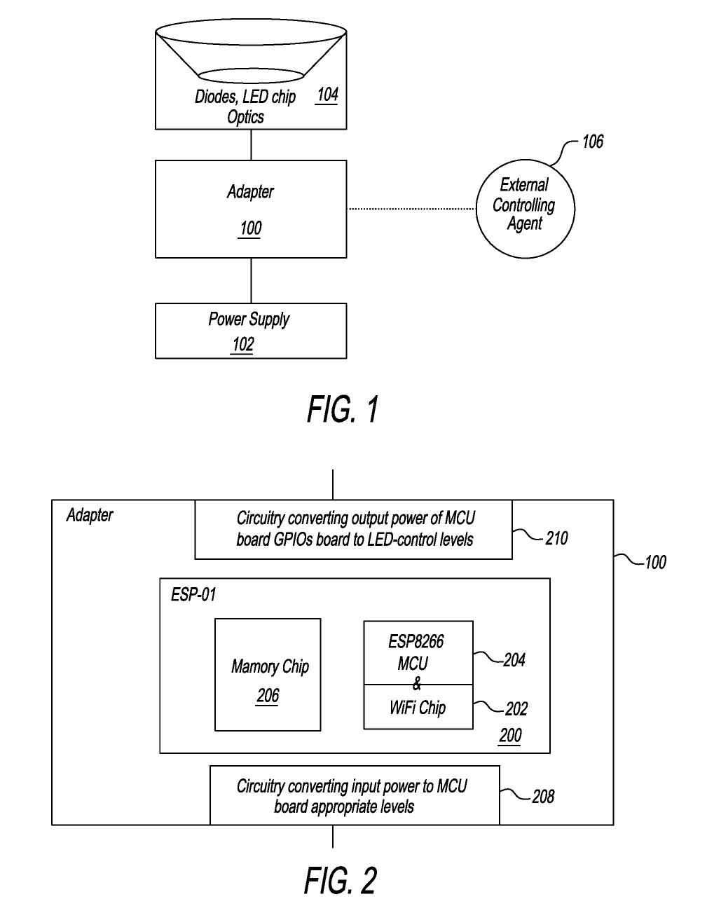

In FIG. 1, an adapter 100, as disclosed herein, is depicted in its inserted state, between a power supply 102 (which may be a battery, or mains electricity, etc.) and an LED light encasement 104, which includes LED circuitry, one or more LEDs themselves, and some optics. Solid lines indicate power transmission wiring. The Adapter is capable of receiving instructions from a controlling agent 106 external to the luminaire over a network, and delivering device status over the same, depicted by a dashed line 108. The instructions sent to the adapter 100 in turn modify the behavior of the LED circuitry as MCU software, discussed below, changes the voltage and/or current in response.

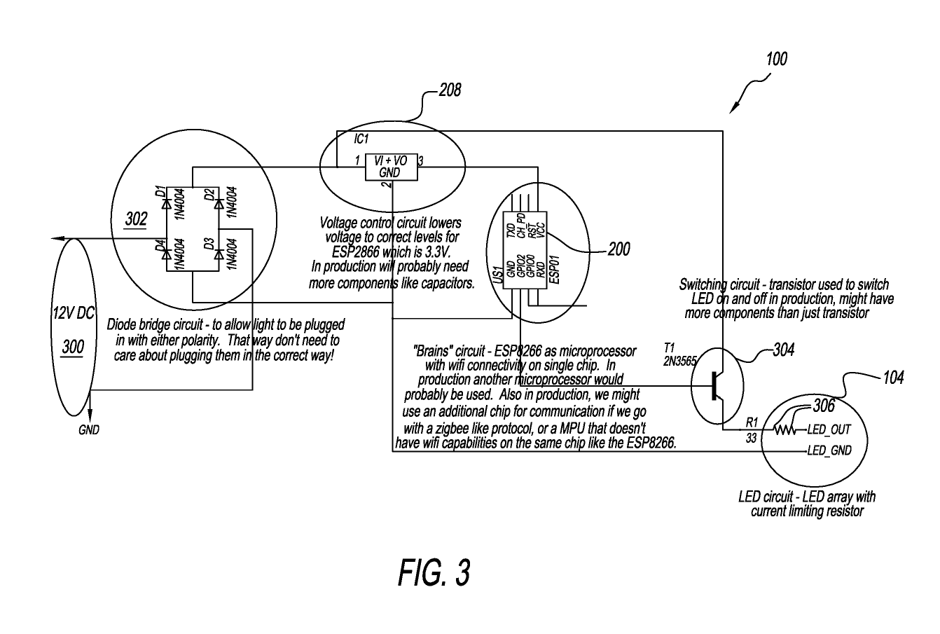

In FIG. 2, more detail of one embodiment of the adapter 100 is depicted. Here, the means by which the external agent networks with the adapter is via WiFi, where the adapter 100, built around a ESP-01 circuit board 200, includes a WiFi chip 202, an MCU 204 and a memory chip 206. It is equally possible to connect adapter 100 to cellular, Ethernet, Ethernet over power, or other network types. The WiFi can be configured to connect to a router (not shown) that provides a communication channel, typically to the broader internet, over which control of adapter 100 can be exerted. The MCU 204, which can be, for example, a type ESP8266, is programmed with software to transform the instructions into altered voltage and/or current levels.

The software program may switch the lights on or off, dim them by switching them on and off rapidly to yield a dimming effect to the human eye, or to rapidly blink the light in patterns that communicate information. The information communicated by the device or adapter 100 may be used for a variety of purposes, including simpler GeoLiFi and more complex streaming of music, movies, or other information to far-end devices capable of receiving LiFi signals. Alternatives abound for the particular hardware board used in this embodiment.

Communication with the network beyond the WiFi point is in one embodiment carried out over the MQTT protocol, which, as a light-weight protocol, reduces power requirements, features faster response, and lower bandwidth use than some other protocols, such as HTTP.

As more fully described below adapter 100 includes input converting circuitry 208 for converting input power to levels appropriate to power circuit board 200 and output converting circuitry 210 for converting the output levels of circuit board 200 to LED control levels.

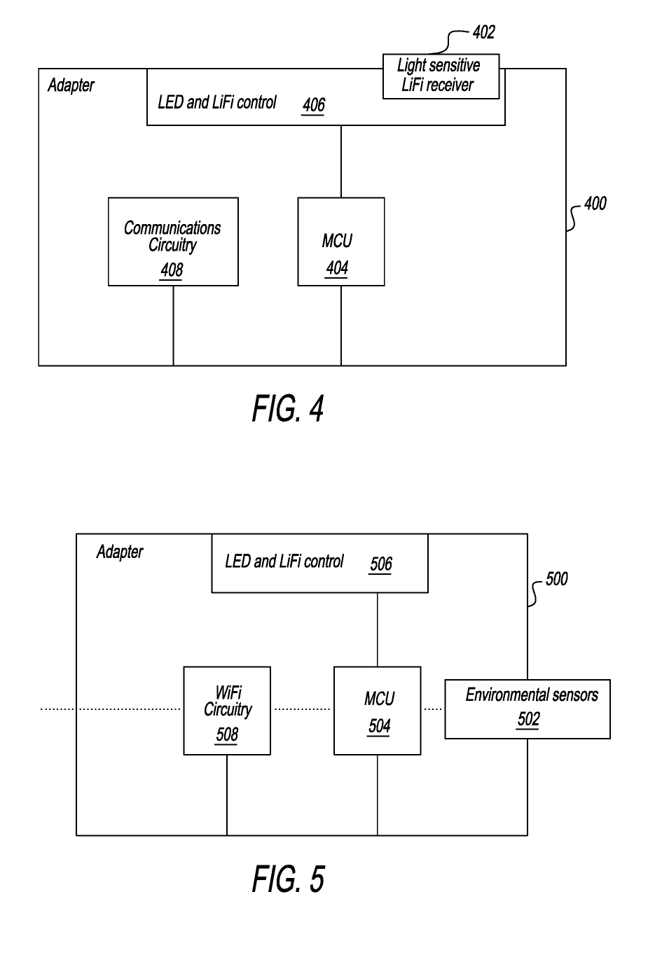

FIG. 3 is the schematic diagram of an embodiment of the adapter 100 that provides a LiFi capability to s device that it does not possess without adapter 100. In this case adapter 100 manages LED lights that are connected to an input 300 from a 12 V DC supply. From a typical mains supply, this requires a power supply (not shown) upstream converting from 120V AV to 12 V DC. A diode bridge circuit 302 permits the 12 V DC to be used regardless of polarity. Circuit 208, which can include smoothing capacitors (not shown) converts input power at 12 V DC to levels appropriate to power circuit board 200 (typically 3.3 volts). The output of circuit board 200 controls a switching transistor 304, which together with a current limiting resistor 306, act as output converting circuitry 210 for converting the output levels of circuit board 200 to LED control levels. Switching transistor 304 switches the output of diode bridge circuit 302 to an LED light encasement 104.

When an LED device is utilized in this manner to provide LiFi or GeoLiFi capabilities, the adapter 100, controlled by a software program, acts as a modulator that transmits content over the carrier light frequency using one of many well-known modulation techniques, tailored to the particular requirements of the transmission requirements.

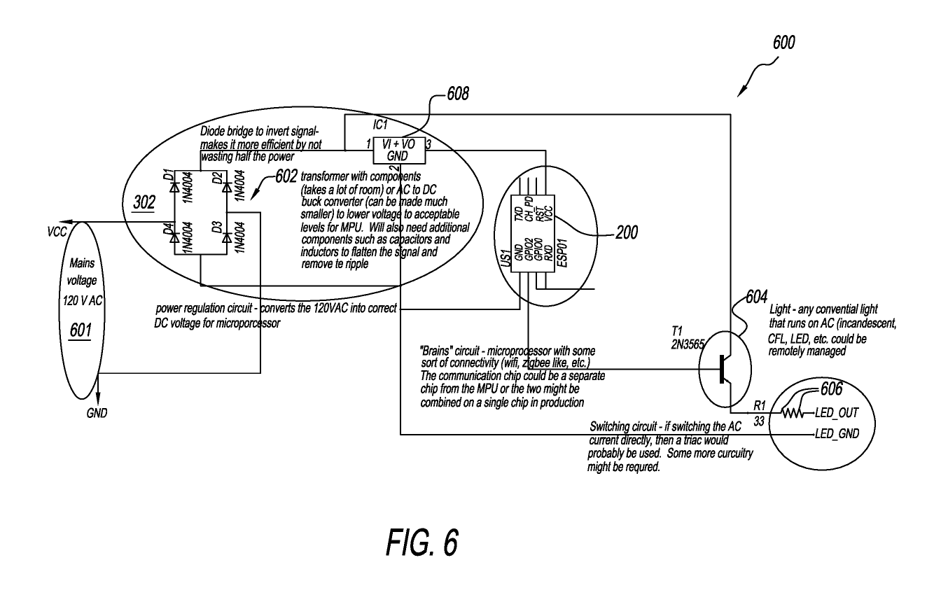

In FIG. 4, an embodiment of an adapter 400 may extend bidirectional communication to a luminaire such as an LED light encasement 104. The resulting full duplex capability extends the computer network beyond the LED endpoint. A light sensitive LiFi receiver or light sensor 402 is present in adapter 400. The sensor 402 allows for the detection of incoming signals transmitted via light. A software program on an MCU 404 modulates the light emitted by the LED controlled by adapter 400 to transmit data, via An LED and LiFi control circuit 406. Here, additionally, the light sensor 402 turns the light signal into an electrical signal that is sampled by a software program on the MCU 404. The software transforms the content of the signal into protocols appropriate for the communications channel (not shown) over which it delivers the received information via communications circuitry 408. It is equally possible and at times advantageous to use a first MCU for outgoing communication, and a second MCU for incoming information, as each MCU can have a separate clock, and a different limit of the speed with which the signals can be sampled.

Adapter 400 is not limited to modulating light, nor is an associated device limited in purpose to control of only light. Since luminaires represents a significant physical presence, they may be leveraged to carry other IoT sensors.

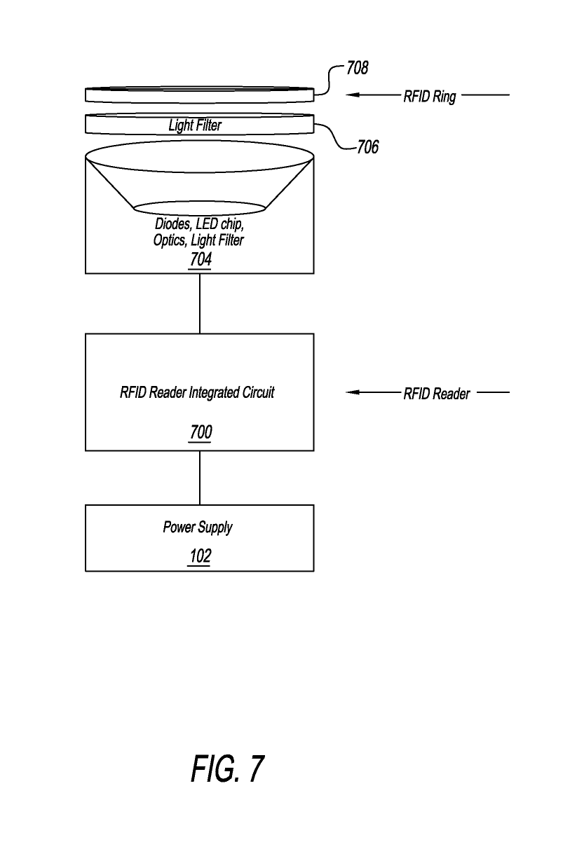

In FIG. 5, in one embodiment, an adapter 500, has additional environmental sensors 502 to collect measurements of the surroundings of the LED being controlled. A software program on an MCU 504 modulates the light emitted by the LED controlled by adapter 400 to transmit data, via an LED and LiFi control circuit 506. The software transforms the content of the signal into protocols appropriate for the communications channel (not shown) over which it delivers the received information via WiFi circuitry 508. Suitable examples of environmental sensors 502 are sensors to measure LED temperature, ambient temperature, ambient light, light color, pressure, and presence of smoke or fire, or air pollutants such as methane, carbon dioxide, carbon monoxide, ozone, hydrogen sulfide, or various hydrocarbons. Other sensors may detect motion of humans. Radar detectors may be used to collect highway automotive speed information.

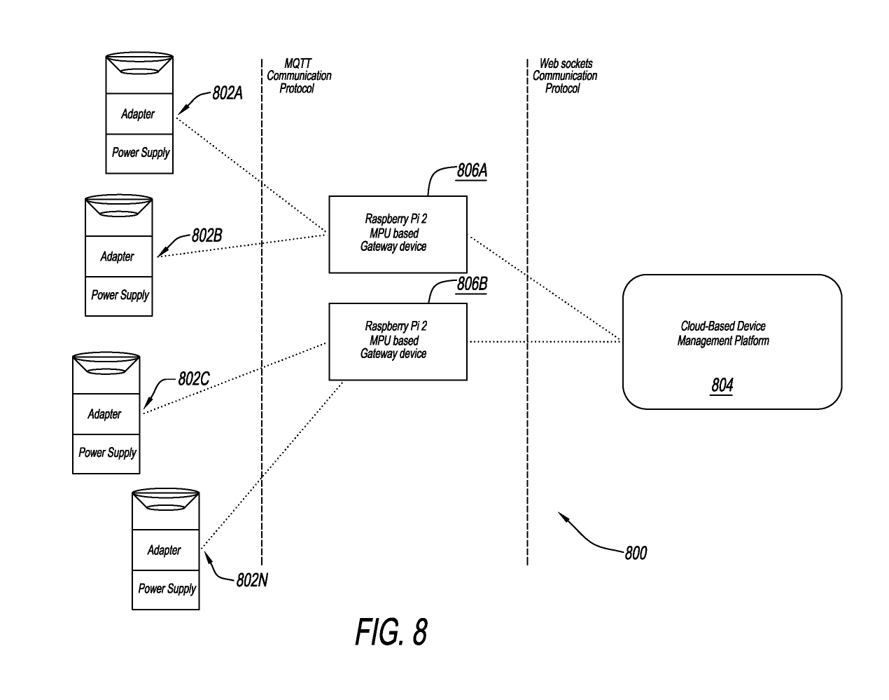

FIG. 6 is a schematic diagram of an embodiment of an adapter 600 that remotely manages a luminaire of any type (incandescent, compact fluorescent (CFL), or LED) running on 120 V AC, and other actuators may be controlled similarly. In this case adapter 600 is connected to an input 601 from typical 120 V AC mains. A diode bridge circuit 602 rectifies the 120 V AC. Circuit 608, which can include smoothing capacitors and inductors (not shown) converts input power at 12 V DC to levels appropriate to power circuit board 200 (typically 3.3 volts). Circuit 608 may be a buck converter to provide voltage step down and current step up. The output of circuit board 200 controls a switching semiconductor device 604, such as a triac (along with additional circuitry of a type well known in the art) which together with a current limiting resistor 606, switches the output of diode bridge circuit 602 to a luminaire of the type described above (for example, an LED light encasement 104).

Well-known circuitry (not shown) can be added to collect readings of other sensor types, according to type. In one implementation, the circuits are designed not for bidirectional LiFi, but to transmit a simple GeoLiFi ID, and to remotely manage the light by turning it on, off, and to dim it.

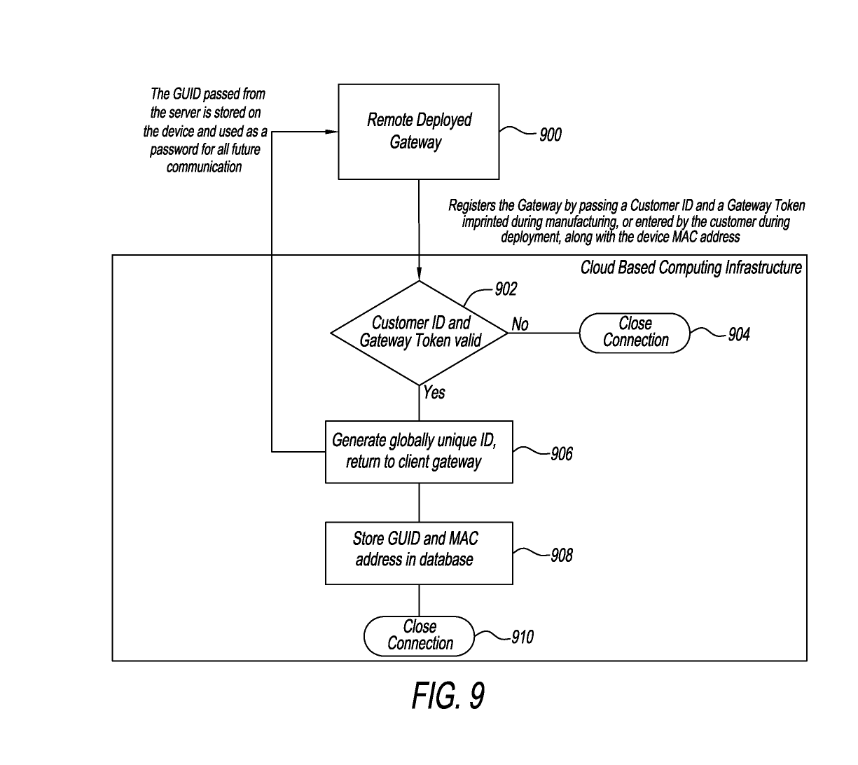

In FIG. 7, an alternative method of configuring an existing LED light encasement 704 to emit a GeoLiFi ID is depicted. For the purpose of changing the ID of an LED, a simplified adapter 700 need not be connected to the outside world (for instance, via a WiFi chip), but is instead outfitted with an RFID (Radio-Frequency IDentification) reader. An RFID ring 708 snaps onto an existing light filter 706 of the LED light encasement 104. When added, RFID ring 708 identifies itself to adapter 700 via the reader of adapter 700 with a unique identifier (ID). The software associated with an MCU chip in the RFID reader of adapter 700 receives the ID, and in turn modulates the light from the LED of LED light encasement 704 to emit the ID. Adapter 700, including the RFID reader may be incorporated within a luminaire at the time of manufacture, while the ring 708 can be added and changed post-deployment.

It is noted that the operation of the gateway devices and the platform for the devices described are fully disclosed in the abovementioned application Ser. No. 14/671,694 filed on Mar. 27, 2015, and published as United States Patent Publication No. 2015/0281337. However, clarifications regarding the secure registration as well as some other aspects of gateways and devices are disclosed below, including schematics diagrams pertaining specifically to the lighting application.

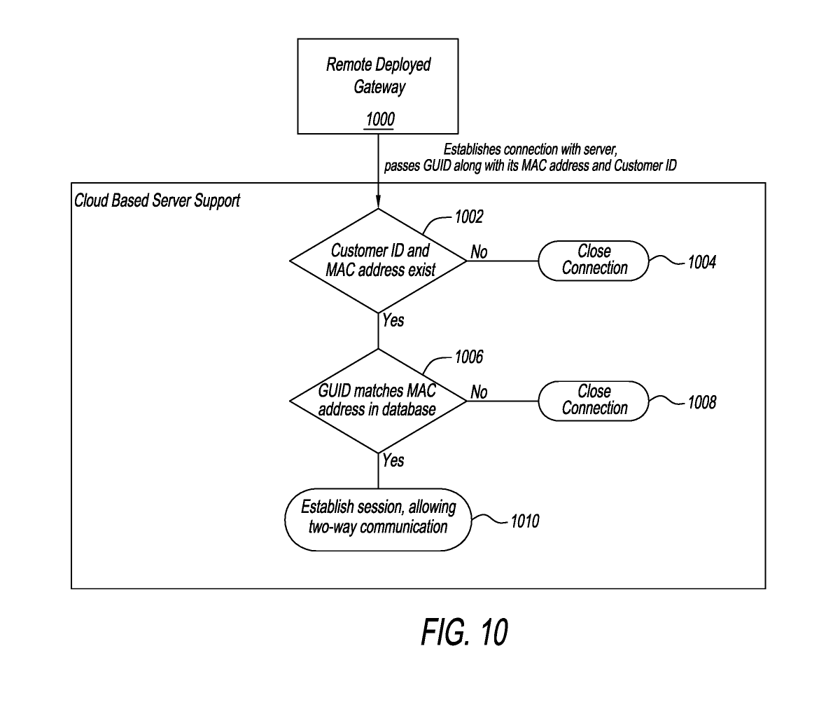

In FIG. 8, the various embodiments are placed in context of a related system 800 whereby data can be collected from and control is exerted over remotely placed devices 802A, 802B, 802C . . . 802N (each device including, for example, a luminaire, an adapter of the type described herein and a power supply or a connection thereto), from a cloud-based management platform 804. Cloud-based management platform 804 includes a sensor readings database. Only key portions of the entire network devices are depicted, not including, for instance, routers. The platform communicates with one or more gateway devices 806A, 806B, etc. using the websockets protocol. The gateway devices 806A, 806B, in turn communicate with one or more adapters of devices 802A, 802B, 802C . . . 802N using the MQTT protocol. Software agents developed by Basic6 (of the type described in application Ser. No. 14/671,694 filed on Mar. 27, 2015, and published as United States Patent Publication No. 2015/0281337) on the internet-addressable gateway devices 806A, 806B, are capable of maintaining full duplex websockets communication channels for real-time control of the remote devices, of routing that information to the correct end-point adapter over MQTT, of receiving sensor readings, making control decisions rooted in the algorithms of the resident software, of exerting the relevant controls corresponding to those decisions, and of delivering sensor readings to cloud-based services. In this manner, the network of the luminaires is not directly connected to, nor accessible from, the internet.

A user driving the management platform can view the sensor readings and the status of the luminaires and associated sensors, and can exercise control of all or a subset of the lights, acting on the subset as a whole, as well as status of and control over the gateway devices. The ability to control the devices includes replacing the software on them remotely, and to deliver security tokens used for secure communications to the devices, as also described in application Ser. No. 14/671,694 filed on Mar. 27, 2015, and published as United States Patent Publication No. 2015/0281337.

In this depiction, the use of the particular communication protocols (websockets, MQTT) and the fact that the management platform is cloud-based, are incidental to the disclosure, and are but one possible embodiment of an encompassing system wherein the disclosed apparatus resides. It is possible to use other protocols, and the management platform may be a device on the local network. While the gateway device can be the Raspberry Pi 2, which is a good prototyping device, alternative devices with various capabilities abound.

Beyond securing devices physically, it is important that a compromised device, gateway or end-point, yields no information that can be used to control other devices on the network. Similarly, it is important that devices or software cannot be introduced into the network in such a fashion so as to pretend to be sending legitimate data of another device (spoofing). This is particularly important since device identifiers such as MAC addresses can readily be garnered by illegitimate devices on a network.

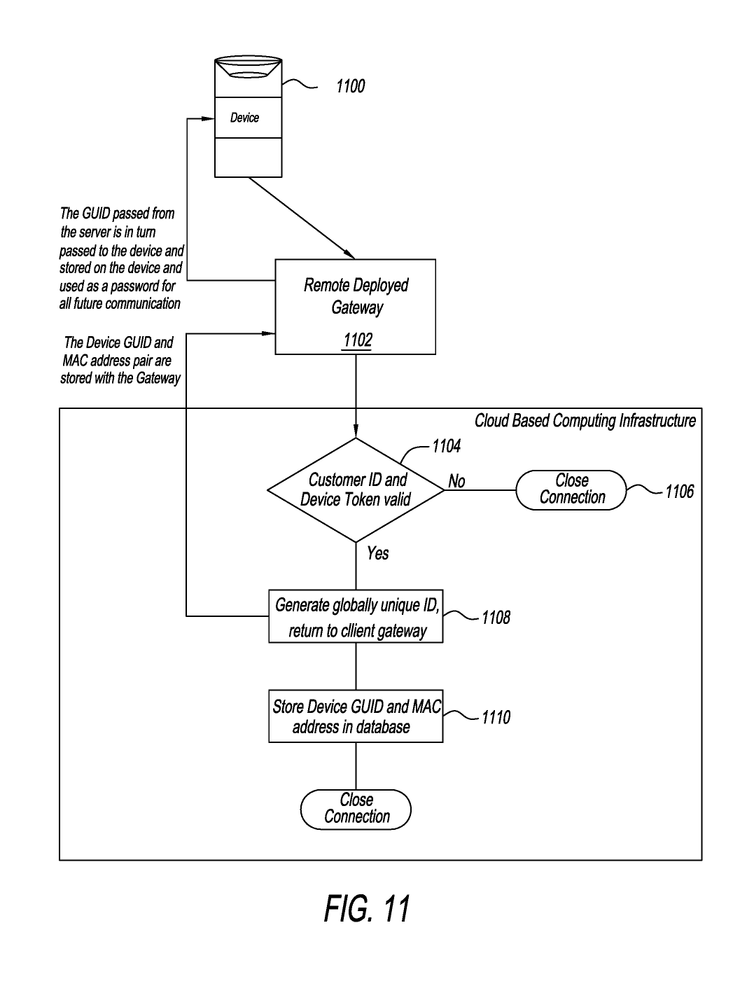

In FIG. 9, an embodiment of the software used to register a gateway 900 to the cloud platform 804 securely, is depicted. Gateway 900 is deployed by passing to the cloud platform 804 a gateway token known only to the user, the customer or user's ID, and the gateway's MAC address, but no token unique to gateway 900. In this way, the software can be imprinted on a large number of gateway devices with no changes to the software image. Once the validity of the customer ID and the gateway token has been established, a globally unique identifier (GUID) password, unique to gateway 900, is generated, and passed to gateway 900. The MAC address and encrypted password are stored in the database, as well as on the gateway 900.

Once the initializing scenario has been completed, the gateway token is completely erased from the gateway 900. Thus, it is not possible to acquire from a compromised gateway tokens to sign up a new gateway. Furthermore, no gateway may again register with the platform using the same MAC address. At any time, the gateway token can be revoked and replaced by a new token, at which point new gateways must use the new token to register with the platform.

Continuing in FIG. 9, at 902, a determination is made as to whether customer ID and gateway token are valid. If they are not, at 904, the connection to gateway 900 is closed. If the customer ID and gateway token are valid, at 906, the GUID is generated, and flow loops back to gateway 900. At 908, the GUID and MAC address are stored in the database, as described above. At 910, the connection to the gateway 900 is closed.

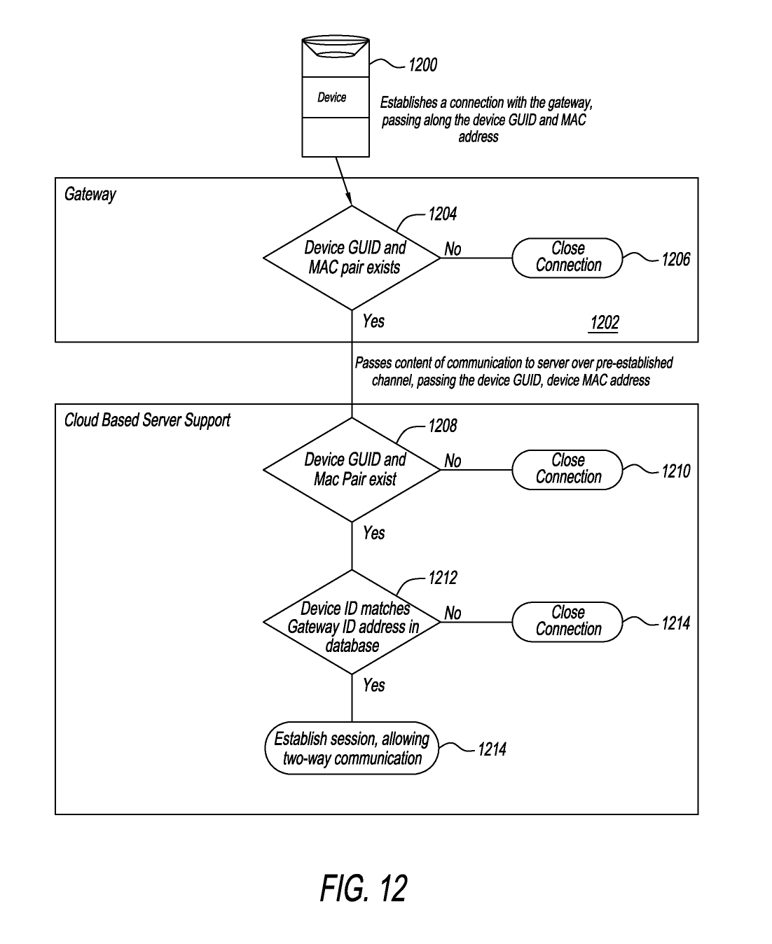

In FIG. 10, the MAC address and GUID are subsequently used as ID and password to identify the gateway 1000 to the platform 804, directed at the Customer ID user. At 1002, a determination is made as to whether the customer ID and MAC address exist. If they do not exist, at 1004, the connection to gateway 1000 is closed. If the customer ID and gateway exist, at 1006, a determination is made as to whether the GUID matches the MAC address in the database. If it does not, at 1008, the connection to gateway 1000 is closed. If it does, at 1010, a session is established, allowing two way communication with gateway 1000. In this embodiment, the websockets connection is secured with SSL/TLS to protect the password. If a gateway is compromised, the password for that particular gateway is compromised as well, but this cannot be leveraged for other devices. If a gateway is compromised and this fact is detected, the password may be revoked and can never be used again.

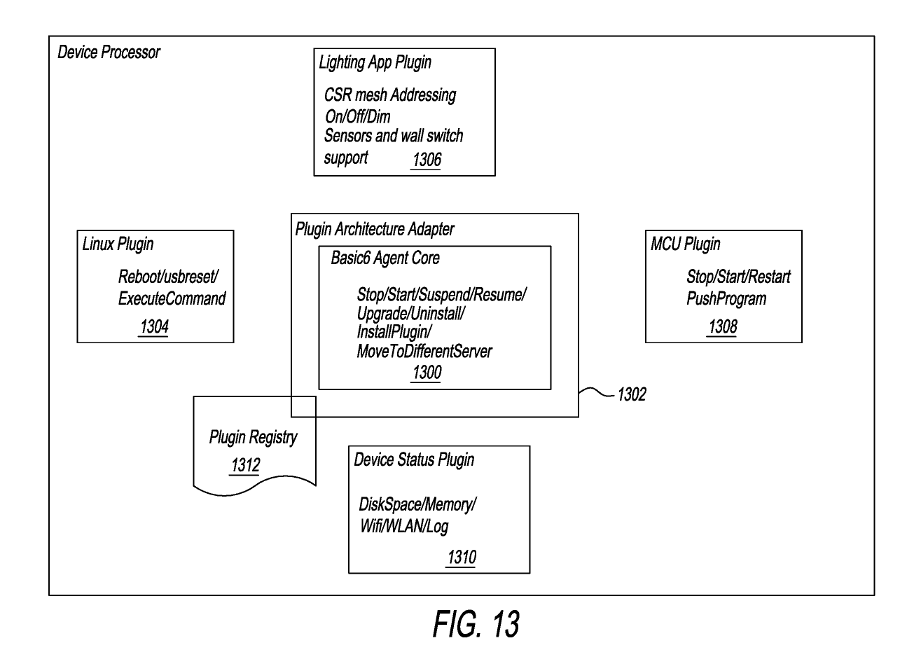

In FIG. 11, a scenario similar to the secure registration of a gateway is depicted. A device 1100 is deployed by passing to the cloud platform a device token known only to the user, the user's Customer ID, and the MAC address of the device 1100, but no token unique to the device. In this way, the software can be imprinted on a large number of devices with no changes to the software image. Once the validity of the customer ID and device token has been established, a GUID password, unique to device 1100, is generated, and passed to the gateway 1102, and from which it is passed on to device 1100. The MAC address and encrypted password are stored in the database as well as on the device 1100 and on the gateway 1102. At 1104, a determination is made as to whether customer ID and gateway token are valid. If they are not, at 1106, the connection to gateway 1106 is closed. If the customer ID and gateway token are valid, at 1108, the GUID is generated, and flow loops back to gateway 1102. At 1110, the GUID and MAC address are stored in the database, as described above. At 1112, the connection to gateway 1102 is closed.

Once the initializing scenario has been completed, the device token is completely erased from device 1100. This way, it is not possible to acquire information from a compromised device token to sign up a new device. Furthermore, no gateway may again register with the platform using the same MAC address. At any time, the device token can be revoked and replaced by a new token, at which point new devices must use the new token to register with the platform.

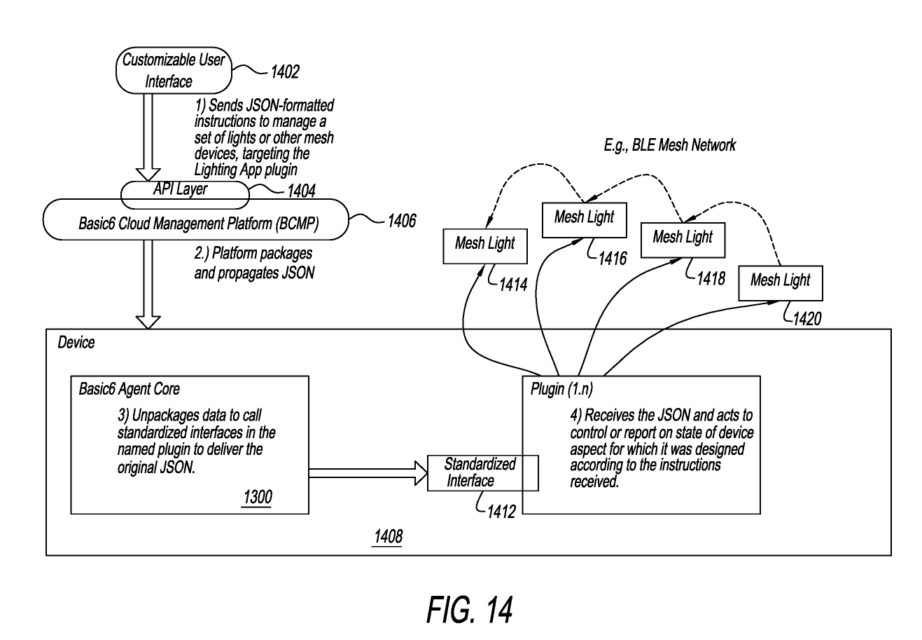

FIG. 12 describes a device 1200 establishing a communication to the cloud platform 804 via a gateway device 1202. Gateway device 1202 is assumed to have already established a secure connection to the cloud platform 804. The GUID and MAC address of device 1200 are used as ID and password to identify the device 1200 to the gateway 1202. Specifically, at 1204, a determination is made as to whether GUID and MAC address of device 1200 exist. If they do not, at 1206, the connection between device 1200 and gateway device 1202 is closed. If the GUID and MAC address of device 1200 exist, flow continues to 1208, where the combination of GUID and MAC address passes on to the platform 804. If the combination of GUID and MAC address does not exist, at 1210, the connection to platform 804 is closed. At 1212, once the platform has validated that the device and MAC pair are valid (validating the device itself), the ID of the device 1200 and the ID of gateway 1202 are checked against the database in the platform 804, thus determining whether device 1200 is attached to the correct gateway. If the ID of the device 1200 and the ID of gateway 1202 do not match, the connection is closed at 1214. If the ID of the device 1200 and the ID of gateway 1202 match, a secure communication session is established at 1214. If a device is compromised, the password for that particular device is compromised as well, but this cannot be leveraged for other devices. Validation of the combination of gateways and devices increase the complexity a challenger must overcome to compromise that part of the system. For instance, surreptitiously moving the device to another gateway, belonging to the same or perhaps to another user, is much more difficult using this approach.

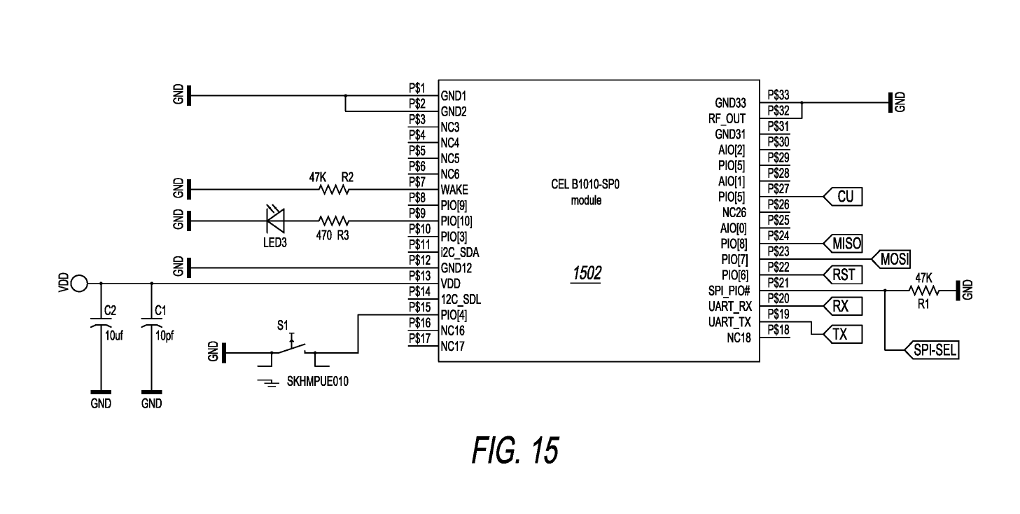

Referring to FIG. 13, in order to support the many variations of device types and configurations of the gateway, mesh network, connected devices, and the application served, the system 1300 described herein is architected to be easily extensible by separating out the generic, communication and self-managing aspects of the device-residing agent, referred to as the core 1300 (within a plugin architecture software adapter 1302), from modules particular to the device configuration, referred to as “plugins”, which can be added, subtracted, or modified for particular device configurations. Plugins may include a Linux plugin 1304, a lighting application plugin 1306, and MCU plugin 1308, and a device status plugin 1310. A plugin registry 1312 is also maintained. The registry retains the identifiers, names, versions, and interface addressing of the plugins to facilitate management thereof, such as which gateways need enhanced plugin versions as they are released. Self-managing aspects of the agent or core 1300 include, but are not limited to, stopping, starting, suspending, and resuming agent activity, upgrading or uninstalling the agent itself, and installing new plugins. Communication management includes an autoconnect feature to maintain the connection should it be lost, as well as the ability to point the connection to a different server address. Pointing a connection to a different server is used for load-balancing purposes pertaining to scalability, and during server upgrades.

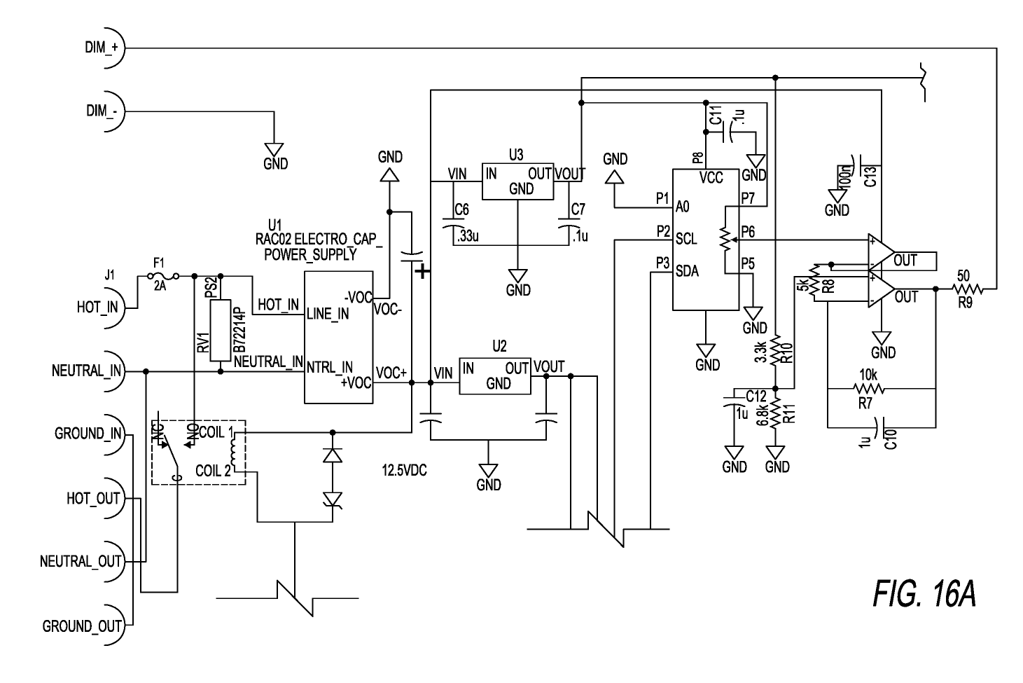

As shown in FIG. 14, the plugins-oriented architecture is achieved by transporting content in a packaged format from the platform particular to the heterogeneous aspects of devices in a fashion agnostic to the core, along with an indication as to the target plugin. The generic portion of the agent software extracts and exports the relevant package information to any number of such plugins over standardized interfaces.

Specifically, a customizable user interface 1402 is used to send JSON formatted instructions to manage a set of lights or other mesh devices, targeting the lighting application plugin 1306 via an application program interface 1404 to the cloud management platform 1406. Cloud management platform 1406 packages and propagates instructions to the devices according to the protocol and encryption schemes used over the local mesh network, such as device 1408. The various plugins 1410A, 1410B, 1410C . . . 1410n receive the instructions via a standard interface 1412, and act, in accordance with the instructions received, to control or report on the state of device aspects for which they are designed. The plugins 1410A, 1410B, 1410C . . . 1410n communicate with a mesh devices, such as mesh lights 1414, 1416, mesh sensor 1418 and mesh wall switch 1420.

Similarly, an interface accepting signals from a plugin allows data to flow in the opposite direction on a schedule, the parameters for which are customizable for each plugin from the platform via yet another dedicated interface method. Throughout, the data delivery and storage portions of the system are agnostic with respect to the nature of the information.

In order to exercise the standard interface methods of multiple plugins, each of which may take more or less time to complete a request, a controlling function in the agent core launches a new thread in an orderly fashion, on which the interface method is exercised. As multiple threads may return control to the core at the same time, a thread-locking mechanism is used to serialize the streaming of information returned to the platform.

To support a new device, any developer may, with this open and flexible architecture, create a plugin to support a new application, gateway device type, or mesh type, or other variations particular to the application so served, the details of which the platform and the core of the agent has no insight. A developer may use common actions available within the existing user interface to enact functions, or create a custom user interface to pass information to and from the plugins installed on the device.

The system is very open. A developer may choose to take advantage of any or all advantages delivered by the system, while developing a plugin that processes any or all application-related data and functionality (for instance, temperature readings with a trigger maximal temperature, the reaching of which will result in a notification to a user) by any other mechanism available to any other target system. In this regard, the system separates not only conceptually the tasks of generic device management and control from the application, but practically and physically, this is at the developer's discretion. The goal of this feature is to allow greater flexibility to the application developer.

The lighting application plugin 1306 (FIG. 13) is responsible for management and status reporting of the lighting application; it is the plugin that is able to communicate with the CSR modules over its serial port, address meshed devices, switch lights On/Off, dim lights, receive status from the wall switch and sensors, as well as update the software of all those components. Software from CSR controls the behavior of the mesh module-to-module interconnection and encryption. The plugin is itself also capable of managing the serialization of data through the serial port to multiple devices and to wait for responses by exercising multiple concurrent threads and using thread synchronizing objects to coordinate their activities.

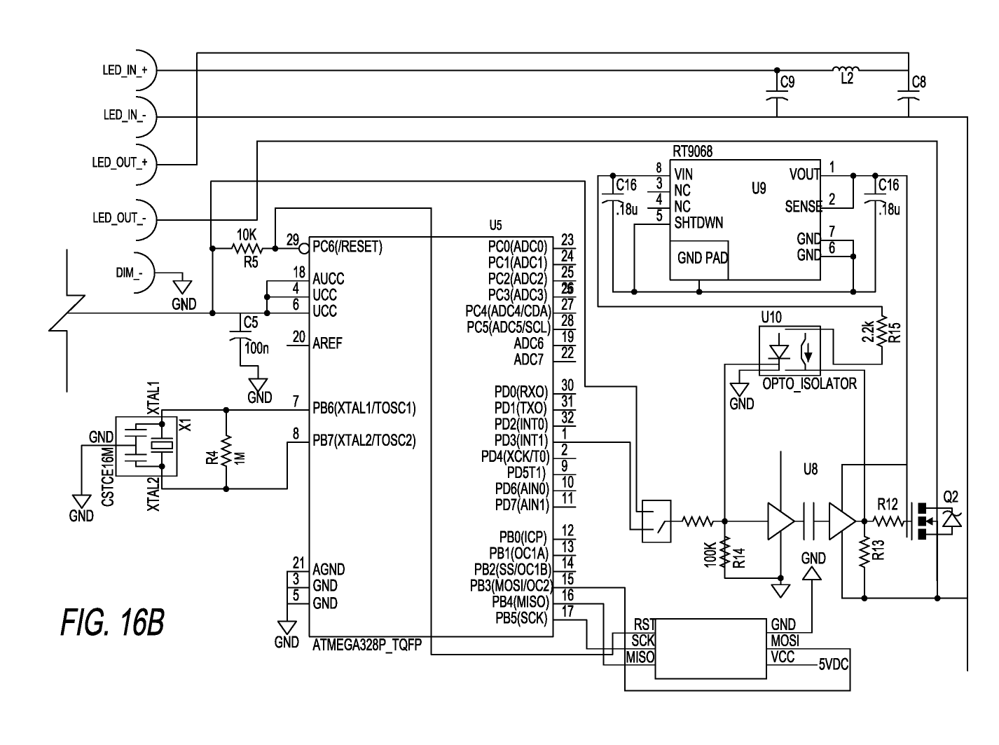

With reference to FIG. 15, the gateway hardware is based on a Raspberry Pi which interfaces with a Bluetooth module in order to communicate with the remainder of the meshed devices. The off-the-shelf Raspberry Pi is chosen for this purpose because of the ease with which development can be carried out with this device. The Basic6 software agent resides on the MPU of the Raspberry Pi, which has communication capabilities to the WLAN via Ethernet and WiFi. A similar device, such as an Arduino Yun, or a customized version of the same can substitute for the Raspberry Pi with trivial changes to the circuitry.

The support components for the CEL B1010-SPO BlueTooth integrated transceiver mesh module 1502 include a few passive SMD resistors to provide pull-up or pull-down of a few connections to allow the module to function normally, including power filtering capacitors C1 and C2 and LED3. Data from the Raspberry Pi is serialized over a UART (not shown). The UART transmit and receive connections are connected directly from the output of the Raspberry Pi to the input of the CSR mesh module 1502 without interruption or regulation. The CSR mesh module is powered at 3.3V from the Raspberry Pi.

The firmware program that operates on mesh module 1502 is largely based on CSR Mesh 1.3 with modifications to allow accepting and processing commands from the UART of the Raspberry Pi. The commands ultimately originate within the Basic6 Cloud infrastructure and are interpreted by the Basic6 agent software. The commands are passed to the CRS mesh module 1502 through the UART connections and are processed by the firmware of mesh module 1502 and propagated through the mesh. The functions used to assemble and process the datagram-level messages are uniquely developed for this purpose and customizable, as are the functions to manage the communication over the UART to and from the Raspberry Pi.

The data on the mesh is encrypted by the software provided by CSR. Since each node on the mesh is capable of decrypting the same, a per-node encryption is added to remove the possibility of a rogue node attached to the mesh reading messages of other devices or spoofing data of another device. Additionally, the GATT Bluetooth advertisement is suppressed, allowing a transparent mesh network. No Bluetooth advertisement or connections are needed since commands are originated and injected into the mesh network remotely over the persistent websocket connections established by the gateway.

The gateway's tact-style pushbutton switch S1, that can be used for testing purposes, and that is connected to one of the module PIO inputs, can be freely programmed to issue mesh transport layer commands locally without the need for going through the Cloud interface. For example, when pressed and released, the gateway issues a light ON command to all mesh connected light modules. When held down for three seconds, a light OFF command is sent to all mesh connected light modules.

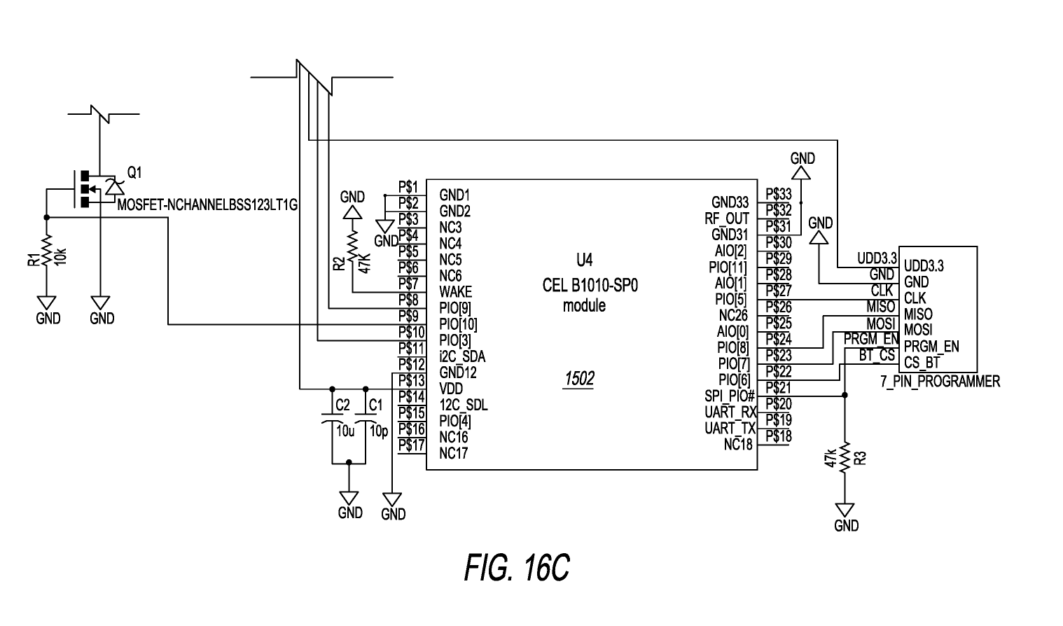

With reference to FIG. 16A, FIG. 16B and FIG. 16C, the lighting control and LiFi board has the following power related components:

F1—Fuse (2-3 A fuse to protect circuit)
RV1—Metal Oxide varistor (basically a surge protector)
U1—AC to DC converter (converts 120 or 240 VAC to 12 VDC)
U2—3.3V linear regulator (drops the 12 VDC to 3.3 VDC for running BT module)
U3—5V linear regulator (drops the 12 VDC to 5 VDC for running Arduino and dimming circuit).

Thus, the power related components or supply circuits convert the 120 or 240 VAC power into 12 VDC, 5 VDC, and 3.3 VDC in order to run the various sub-circuits. The 12 VDC is used for a relay K1, and the dimming operational amplifier U7. The 5 VDC is used to power the Arduino chip U5 used for LiFi and the digital potentiometer U6 for dimming. The 3.3 VDC is used for the BlueTooth mesh module U4.

Communication

The CSR Mesh Bluetooth Module, U4, empowers the board with its wireless communication capabilities to and from the gateway and all other nodes on the same mesh, and matches that of all other meshed devices.

Managing Lights On/Off is accomplished with the following components:

Q1—An N-Mosfet used to switch the relay K1 on and off.
Z1—A 20 V Zener diode used to ensure that relay closes fast enough. Using the diode alone in parallel with the coil on the relay does not allow the relay to close quickly as there are still remaining currents looping through the diode and relay preventing the relay from opening quickly which can create arcing that can harm the relay over time. Adding an approximately 20 V Zener diode allows the relay to close more quickly while still limiting the maximum voltage spike to 20 V, which is below the damage threshold of transistor Q1.
K1—Is the relay to switch lights on and off at 120 or 240 VAC.
D1—Is a diode to prevent a voltage spike when switching relay K1 that would damage Q1.
R1—Is a pull down resistor for the gate of Q1 for reliability.

As described above, relay K1 is used to switch the driver on and off. While this is a quick and reliable solution used in this particular embodiment, an alternative that uses TRIACs to switch the AC power to the driver may be preferred: a TRIAC has the advantage of being smaller and having no moving parts so as to not degrade with use, and can be introduced with only slight changes to the circuit.

Managing Dimming is accomplished with the following components:

U6—This is a digital potentiometer controlled by I2C.
U7—This is a dual power operational amplifier in a single chip.
One of the operational amplifiers is used as a buffer (non-inverting) to prevent current from being drawn by the W terminal of the digital pot, and the other operational amplifier is set up in an inverting configuration and as a voltage controlled current sink so dim values can be controlled from the driver. The dimming circuit is compliant with the 0-10V dimming standard (IEC 60929), and may be referred to as a voltage controlled current sink. The amount of current being sunk by the circuit is directly proportional to the control voltage applied. Using the operational amplifier for current sinking, in an inverting configuration provides an easy way to bandwidth-limit the signal compared to a non-inverting configuration. Using the operational amplifier in non-inverting mode for current sinking would also work but would require a few additional passive components.

The voltage signal used to control the operational amplifier is derived from digital potentiometer U6. Digital potentiometer U6 is connected via an I2C bus to the Bluetooth communication module U4. I2C protocol commands coming from the BlueTooth control board set the wiper of the potentiometer to the desired voltage. The digital potentiometer has three main terminals (A, B, and the wiper, W). A resistive material connects terminals A and B and the wiper slides on this resistive material so that the resistance between A to W and B to W changes as the slider moves. Terminal A is connected to 5V while terminal B is connected to ground. As a result, a voltage divide is created where the wiper terminal, W, can sweep anywhere between the 0 and 5V levels.

As described above, this control voltage feeds a non-inverting operational amplifier buffer, which ensures that no current flows out of terminal W, in order to protect the digital potentiometer. The digital potentiometer is sensitive to currents so that a small current flowing between terminals A to W or W to B of the operational amplifier could destroy the digital potentiometer U6. This is a simple alternative to precisely adjusting the operational amplifier in the current sink, which is also a valid configuration.

The 0-5 volts created by the digital potentiometer U6 is proportional to the dimming level achieved. For example, 5 V on the output of the digital potentiometer U6 would cause the dim signal to be a 10V, which would result in maximum light brightness. If the output of the digital potentiometer U6 were at 0 V, then the dim signal would also be at 0 V yielding the minimum dim level.

The LiFi circuit is here in a configuration independent of the BlueTooth mesh module 1502 (FIG. 15). Versions where they are connected and where remote configuration of the emitted LiFi ID is thus enabled are not depicted, but are readily envisioned.

While the BlueTooth control module does not allow the very precise timing needed by the LiFi signal so it cannot create the modulation signal, the MCU is capable of doing so. Alternative BT modules precise enough to create the modulation signal exclude the need for the MCU altogether.

The circuitry includes the following components:

U5—ATMEGA328p MCU used to generate the LiFi modulation signal
3-PIN-HEADER—Used to disable LiFi when not desired
U8—This is a digital isolator that allows a high/low signal to propagate from one side to the other without a direct electrical connection. It is used because an opto-isolator is too slow for purposes of signal modulation at the desirable rates of transmission. Isolation is necessary between the LiFi side and the control side as ground levels of the two sides may not match. Some drivers have the ground for their dimming circuit at a different potential than the ground for their LED circuit. Here, because the control side ground is at the same level as the dimming ground, in the absence of an isolator a short would result when connecting the LED's ground and the dim ground.
U9—This is a 5 V linear regulator. One side of the digital isolator needs its own power supply to maintain isolation. On the control side, the power comes from the 5 V rail. On the LED side a 5 V signal is required with respect to the LED ground in order to power the LED side of the digital isolator for which reason the linear regulator is used. This particular linear regulator can take an input voltage as high as 60 V so as to not be damaged by the 0 to 50 volts that can be outputted by the driver at the LED output.
U10—This is an opto-isolator, that enables an optional isolation method used during development. Final versions of the boards generally will not contain U10, R13, R14, and R15.
Q2—This is an NMOS transistor used for switching lights on and off. This transistor receives the LiFi modulation signal from the digital isolator and causes the lights to “blink” the modulation signal.
C8, C9, and L2—These components form a Pi (π) filter for LiFi modulation.
This circuit allows modulation of the LED lights while minimizing the noise caused by the modulation experienced by the driver.
C8 is 68 uF, C9 is 68 uH, and L2 is 220 uH. This Pi filter serves to protect the driver from the noise caused by the switching of the LED's. Without this circuit, the driver would directly see the full modulation signal and typically not operate properly due to its constant current nature. The driver would keep dumping current, so when Q2 is off it cannot keep flowing current. To protect themselves, in response to this condition drivers, which can contain sophisticated reactive circuitry, usually turn themselves off, which would interfere with the desired operation of the circuit. Instead, by adding the capacitors C9 and C8, the flow current out of the driver is maintained when Q2 is off When Q2 is off, the current from the driver charges the capacitors. When Q2 is turned back on, the current from the driver flows to the LED's; as a result C8 and C9 discharge so that the energy stored in C8 and C9 also goes to the LED's. C8 and C9 will discharge exponentially and are finished discharging, ready to be recharged, by the time Q2 turns off again. Overall, adding C8 and C9 allows the switching on and off of the LED's without interrupting the flow of current from the driver.

While the current flow is maintained, the voltage on the LED's is not constant. When Q2 is switched off, the voltage increases exponentially as the capacitor charges up. When Q2 switches back on, there is a narrow voltage spike caused by the exponential discharging of the capacitors until the capacitors are discharged. Thus, if only C8 and C9 are used, the voltage levels would be passed to the driver which could negatively impact the driver's behavior or long-term stability. To minimize the voltage noise to the driver, L2 is added to the circuit between C8 and C9 to form the Pi filter. This Pi filter serves to reduce the amount of noise that the driver can see so that the driver is less stressed. This Pi filter is a low-pass set with a cutoff frequency low enough to attenuate the strong 2.5 KHz LiFi modulation signal component in order to attenuate the noise that the driver experiences.

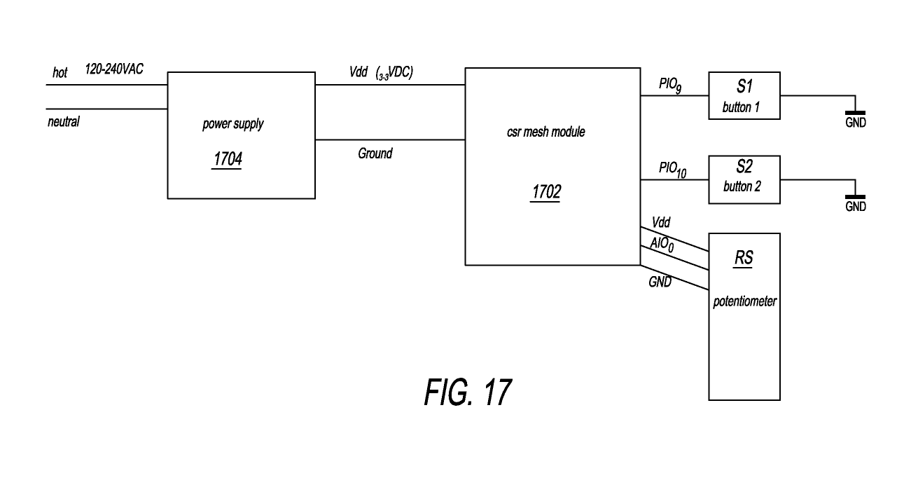

With reference to FIG. 17, this switch device provides local control of a network of mesh-connected lighting fixtures while also relaying its state to the gateway. Physically it may present a tilting paddle on the face which can be tapped at the top to turn lights ‘ON’, and tapped at the bottom to turn lights ‘OFF’, with a slider to control the dimming of the connected light fixtures. The switch can installed as a drop-in replacement for a new or existing wall switch.

The circuitry is simple in its conception, with the central CSR B1010-SPO module 1702 used to process data from the sliders and buttons via the mesh transport layer. The ‘ON’/‘OFF” functions are triggered by 2 small pushbuttons S1 and S2 that are connected to the module via Programmable Input Output (PIO) pins. Switch de-bouncing is handled by the firmware. Power is supplied by a power supply 1704.

In FIG. 17, the slider or potentiometer RS has a varying voltage output. The output of potentiometer RS is connected to the module 1702 via an Analog Input Output (AIO) pin that reads the voltage and translates the value into a 16-bit digital data stream. The voltage provided by the potentiometer RS is polled at a regular time interval and if the change in the value is above or below a set threshold, the new value is sent via the mesh to the connected light fixtures to update the brightness level. All commands sent via the mesh transport layer are echoed directly to the gateway and from there to the Cloud for further processing or logging.

Logical grouping can be handled dynamically by the Cloud/Gateway commands. Lights can easily be moved and re-associated to a particular switch at any time. This allows flexibility since light fixture control can be modified without changes to the hard-wiring of the site.

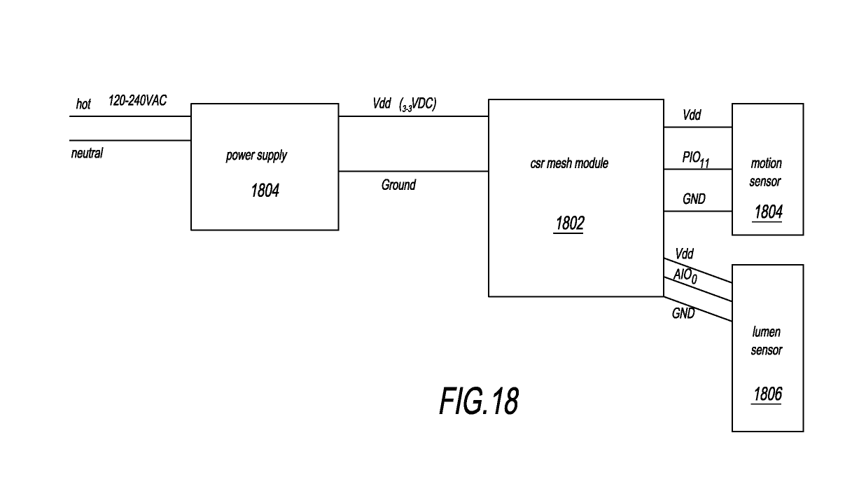

With reference to FIG. 18, the sensor device is intended to provide local control of a network of mesh-connected lighting fixtures. The printed circuit board may contain a BlueTooth mesh module 1802. The printed circuit board may also feature two sensor apertures on the face for a curved motion sensor 1804 which can detect motion and presence up to approximately 8 meters away in a 100 degree arc, and a lumen or light intensity sensor 1806 that measures the light level in the space in front of the device. Power is supplied by a power supply 1804.

The PIR/motion sensing can be handled by, for example, a pre-made module (Parallax, Inc; 555-28027) which connects to the main printed circuit board (PCB) with a 3-pin connector. The module sends a digital ‘ON’ on a pin whenever movement is detected, and drops to an ‘OFF’ state shortly after. This state change is sensed by module 1802 (which may be a CSR B1010-SPO module) on a digital PIO pin. Persistent area motion and time-out is handled by configurable values in the firmware. When motion is first detected, a message is sent via the mesh transport layer to the connected lighting fixtures. No change in lighting status is sent while motion is persistent in the detection area of the device. After the module senses that there is no motion, a pre-set time-out timer starts. If the timer is not interrupted by motion in the area and is allowed to lapse, a message is sent to the connected lighting fixtures to turn off. All messages sent via the mesh transport layer are echoed directly to the gateway and the Cloud for further processing and logging.

The light intensity level (lumen) measurements can be handled by, for example, a pre-existing module (Adafruit Industries, Inc, 1384) which connects to the main PCB via a 3-pin connector. An Analog Input Output pin connects the output of the module to 1802. Intensity sensor 1806 senses the light level and translates that to a variable voltage level. The intensity sensor 1806 is polled at a regular interval by the firmware, and the readings are compared over time. If the readings differ by a programmed threshold, an update is sent to the connected lighting fixtures via the mesh transport layer in the form of a dimming level in an attempt to keep the light level in the room constant. The lumen readings are also sent directly to the gateway and the Cloud for further processing and logging.

The logical grouping of luminaires connected to the sensors are handled dynamically by the Cloud/Gateway commands. Lights can easily be moved and re-associated to a particular sensor at any time. This allows flexibility at any time configuration changes are desired. Changes to the hard-wiring of the site are not required.

Another advantage of the system, and specifically of the mesh communication thereon, is that if communication with a gateway should fail, devices associated with luminaires can still be independently controlled by other parts of the same mesh, even though communication via an external network to, for example, the Cloud may not be available.

It will be understood that the disclosure may be embodied in a computer readable non-transitory storage medium storing instructions of a computer program which when executed by a computer system results in performance of steps of the method described herein. Such storage media may include any of those mentioned in the description above.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof.

What is claimed is:

1. An apparatus comprising:
a luminaire;
a power input for the luminaire; and
an adapter for connection between the luminaire and the power input for controlling the luminaire, by at least one of the adapter modulating light output of the luminaire to contain information, or the adapter having a connection to a network so that the luminaire communicates via signals on the network.

2. The apparatus of claim 1, wherein the luminaire includes at least one LED.

3. The apparatus of claim 1, wherein the luminaire includes at least one of an incandescent bulb and a CFL bulb.

4. The apparatus of claim 1, wherein the network includes the Internet, and the luminaire is remotely controlled by signals sent via the Internet.

5. The apparatus of claim 1, wherein the adapter controls the luminaire to provide LiFi signals.

6. The apparatus of claim 5, further comprising an RFID ring, wherein the adapter comprises circuitry for modulating the light supplied by the luminaire with an identification corresponding to an identification associated with the RFID ring.

7. The apparatus of claim 1, wherein the adapter is retrofitted to existing luminaires.

8. The apparatus of claim 1, wherein the adapter is integrally included in luminaires at the time of manufacture.

9. The apparatus of claim 1, further comprising:
at least one sensor having sensor output, associated with the adapter; and
circuitry associated with the adapter for providing signals indicative of the sensor output to be supplied to the network.

10. The apparatus of claim 9, wherein the at least one sensor is selected from the group consisting of sensors for measuring LED temperature, ambient temperature, ambient light, light color, ambient pressure, presence of smoke, fire, air pollutants, methane, carbon dioxide, carbon monoxide, ozone, hydrogen sulfide, or various hydrocarbons, motion, and speed.

11. The apparatus of claim 1, further comprising at least one of WiFi, cellular, Ethernet, Ethernet over power, or other network types of communications circuitry associated with the adapter for communicating with the adapter.

12. The apparatus of claim 1, wherein the signals associated with the luminaire control the luminaire.

13. An adapter for connection between a luminaire and a power input for powering the luminaire, comprising:
circuitry for modulating light output of the luminaire to contain information, or circuitry for connection to a network so that signals associated with the luminaire are communicated on the network.

14. A method for registering a gateway device having a MAC address, with a management platform, comprising:
assigning a token to the gateway device;
associating the gateway device with a user ID and the token;
sending a globally unique identifier from the management platform to the gateway device if the customer ID and token are valid; and
storing the globally unique identifier and the MAC address in a database of the management platform.

15. The method of claim 14, further comprising:
establishing a communications session between the gateway device and the management platform when the user ID and the MAC address exist and when the globally unique identifier matches the MAC address in the database.

16. The method of claim 14, further comprising deleting the token from the gateway.

17. A method for registering a device having a MAC address with a gateway, comprising:
assigning a token to the device;
transmitting the token and the MAC address to the gateway;
confirming that a user ID and the token are valid;
generating a globally unique identifier for the device; and
storing the globally unique identifier and the MAC address in a database of a management platform that manages the gateway.

18. The method of claim 17, further comprising:
establishing a communications session between the gateway device and the management platform when the globally unique identifier and the MAC address exist, and when the ID of the device matches an gateway ID address in the database.

19. The method of claim 17, wherein the device is a luminaire.

20. The method of claim 17, wherein the luminaire includes at least one LED.

21. The method of claim 17, wherein the luminaire includes at least one of an incandescent bulb and a CFL bulb.

22. A system comprising:
a plurality of luminaires;
a plurality of devices for interaction with or control of the luminaires;
a power input for the luminaires and the devices; and
communication apparatus associated with each of the luminaires and the devices for mesh communication between the luminaires and the devices for controlling the luminaires by at least one of modulating light output of the luminaires to contain information, or a connection to a network so that the luminaires communicate via signals on the network.

23. The system of claim 22, further comprising:
a sensor device for sensing ambient conditions at the location of the sensor device; and
communication apparatus associated with each of the sensor devices for mesh communication with the network.

24. The system of claim 23, wherein the sensor is one of a light intensity sensor, a motion detector, a temperature sensor, and a power measuring device.

25. The system of claim 22, further comprising:
an actuator; and
communication apparatus associated with the actuator for mesh communication with the network.

26. The system of claim 22, further comprising:
a wireless communication beacon; and
communication apparatus associated with the wireless communication beacon for mesh communication with the network.

27. The system of claim 22, wherein the communication apparatus comprises:
plugin software architecture for the luminaires and the devices; and
a gateway for mesh communication with the plugins.
